(19) United States
(12) Patent Application Publication
(10) Pub. No.: US 2012/0021941 A1
(43) Pub. Date: Jan. 26, 2012

(54) BLOOD TEST FOR THE DETECTION OF CANCER

(75) Inventor: Amy B. Heimberger, Houston, TX (US)

(73) Assignee: THE BOARD OF REGENTS OF THE UNIVERSITY OF TEXAS SYSTEM

(21) Appl. No.: 13/144,250

(22) PCT Filed: Jan. 12, 2010
(86) PCT No.: PCT/US10/20788

§ 371 Date: Sep. 29, 2011

Related U.S. Application Data
(60) Provisional application No. 61/144,026, filed on Jan. 12, 2009.
(60) Provisional application No. 61/151,398, filed on Feb. 10, 2009.

(51) Int. Cl. C40B 30/04

(52) U.S. Cl. 506/9

(57) ABSTRACT

Methods of detecting cancers are provided. In certain embodiments, a blood test may utilized to identify the presence of a cancer such as, e.g., a melanoma or glioma (e.g., an astrocytoma, a glioblastoma multiforme) in a human patient. In particular, increased p-STAT3 expression by peripheral blood mononuclear cells is selectively associated with the presence of certain cancers. In various embodiments, fluorescence activated cell sorting (FACS) may be used to measure p-STAT3 expression in the peripheral blood of a human patient.

This application claims priority to U.S. Application No. 61/144,026 filed on Jan. 12, 2009, and U.S. Application No. 61/151,398 filed on Feb. 10, 2009, the entire disclosures of which are specifically incorporated herein by reference in their entirety without disclaimer.

This invention was made with government support under CA120813, awarded by the National Institutes of Health. The government has certain rights in the invention.

### BACKGROUND OF THE INVENTION

1. Field of the Invention

The present invention relates generally to the fields of molecular biology and medicine. More particularly, it concerns diagnostic methods and kits for cancers, such as melanomas and gliomas.

2. Description of Related Art

Signal transducer and activator of transcription 3 (STAT3) is a clinically significant transcription factor whose phosphorylation results in its activation, nuclear translocation, and the upregulation of various oncogenic gene products (Wang et al., 2004). Phosphorylated STAT3 (p-STAT3) serves as an intersection point for many upstream pathways and p-STAT3 activation is implicated in tumorigenesis (Sumimoto et al., 2006). Aberrant or overactive STAT3 is correlated with tumor cell proliferation, abnormal cell cycling, vascular endothelial growth factor overproduction and angiogenesis, impaired apoptotic mechanisms, and immune escape. Immune escape, or the ability of tumor cells to avoid detection and destruction by a patient's immune system, promotes tumor aggression, malignancy, and metastasis (Heinrich et al., 2003; Prendergast, 2008; Sumimoto et al., 2006; Wang et al., 2004).

STAT3-mediated immune escape is relevant in the vast majority of malignancies (Yu et al., 2007) and impedes anti-tumor immune responses that can lead to continued growth and increased malignancy. STAT3 has been found to be constitutively activated in 50-90% of all human cancers and specifically within 81% of central nervous system (CNS) metastatic melanoma (Xie et al., 2006) and at least 53% of high-grade gliomas (Abou-Ghazal et al., 2008). In gliomas, reactive astrocyte elaborated cytokines such as interleukin-6 (IL-6) (Lau et al., 2001; Li et al., 2003) and the constitutively activated growth factor receptors such as epidermal growth factor receptor (EGFR) (Li et al., 2003) cause the phosphorylation and constitutive activation of STAT3. Once activated, p-STAT3 transcriptionally activates multiple immunosuppressive cytokines, including tumor growth factor (TGF-β), vascular endothelial growth factor (VEGF), and interleukin-10 (IL-10). These factors have been shown to modulate and inhibit immune cells such as dendritic cells by activating the STAT3 within the cells (Kortylewski et al., 2005).

Despite the biological influence of STAT3 activation in the development of metastatic cancers which can evade immune detection, the clinical options for evaluating STAT3 activation are limited. A metastasis present in the CNS may express activated STAT3; however, detecting the existence of such a metastasis can be a difficult task for clinicians and may require the use of particularly expensive techniques (e.g., computed tomography (CT) or magnetic resonance imaging (MRI)). Further, even if such a metastasis is identified, the determination of the presence of absence of STAT3 activation in a CNS metastasis using current techniques may typically present too many risks (e.g., damage to the CNS when obtaining a biopsy) to warrant utilization clinically. Clearly, there exists a need for improved methods for the detection and diagnosis of cancers.

### SUMMARY OF THE INVENTION

The present invention overcomes limitations in the prior art by providing methods for detecting the presence of a cancer, such as a metastatic cancer or primary glioma, or increased risk to a cancer by measuring p-STAT3 in the blood of a subject. p-STAT3 expression in the peripheral blood may be detected via techniques including FACS and/or PCR. In various embodiments, the inventor has surprisingly discovered that p-STAT3 expression in a blood sample taken from a subject may be more effectively evaluated if the sample is analyzed within about a 24 hour period after being obtained. In certain embodiments, peripheral blood mononuclear cells (PBMCs), or one or more component from or cell-type of the PBMCs (e.g., dendritic cells, T-cells, etc.), may be substantially purified from the sample and tested for p-STAT3 expression, wherein increased levels of p-STAT3 indicate the presence of or increased risk to a cancer. These methods may also provide substantial cost benefits as compared to presently available methods for the detection of metastases. In various embodiments, evaluation of p-STAT3 expression in a biological sample, such as a blood sample, may be used as a clinical trial biomarker.

An aspect of the present invention relates to a method for detecting, or determining an increased risk of developing, a cancer in a human subject comprising detecting expression of phosphorylated STAT3 (p-STAT3) in PBMCs of such a subject, wherein detecting expression of p-STAT3 in greater than about 7% of such PBMCs indicates that the subject has or is at an increased risk of having the cancer. The method may comprise contacting a sample comprising PBMCs with an antibody selective for p-STAT3; separating or quantifying cells based on binding to such an antibody; and determining the fraction of PBMCs that bind to the antibody. The method may be carried out in a device adapted to separate or quantify cells on the basis of antibody binding, and further wherein said device is programmed to provide a report that identifies the fraction of PBMCs that bind to the antibody. The device may be fluorescence-activated cell sorting (FACS), such as a blue argon laser FACS, and the antibody may be a Y705 antibody. The detecting may comprise detecting or quantifying STAT3 mRNA, e.g., via real-time PCR. The patient may be suspected, or at risk, of having a cancer selected from the group consisting of melanoma, glioma (e.g., astrocytoma, ganglioma, glioblastoma multiforme), leukemia, squamous cell carcinoma, pancreatic cancer, bladder cancer, B-cell non-Hodgkins lymphoma, myeloma, chronic myelogenous leukemia, cervical cancer, breast cancer, and lung cancer. The cancer may be a glioma, such as a ganglioglioma, an anaplastic astrocytoma, an anaplastic oligodendroglioma, or a recurrent glioblastoma multiforme. As shown in the below examples, patients who have a glioblastoma multiforme which is without tumor progression may display p-STAT3 levels within the range of healthy subjects. The cancer may be a metastatic cancer. The cancer may be present in the central nervous system of said subject. The measuring may be performed within about 24 hours or within about 12 hours after said obtaining. The measuring may comprise detecting p-STAT with an immunologic test, such as FACS. In certain embodiments, peripheral blood lymphocytes are substantially purified from the blood sample prior to said FACS analysis. The FACS may comprise use of blue argon laser FACS and/or a Y705 antibody. The measuring may comprise detecting or quantifying STAT3 mRNA, e.g., via real time PCR. The cancer may be a melanoma, glioma, astrocytoma, glioblastoma multiforme, leukemia, squamous cell carcinoma, pancreatic cancer, bladder cancer, b-cell non-Hodgkins lymphoma, myeloma, chronic myelogenous leukemia, cervical cancer, breast cancer, lung cancer, or a metastatic cancer. The metastatic cancer may be present in the central nervous system of said subject. The expression of p-STAT3 in greater than about 7%, or greater than 10%, of said peripheral blood mononuclear cells may indicate that the subject has or is at an increased risk of having said cancer. p-STAT3 expression may be observed in less than about 7% of said peripheral blood mononuclear cells.

Another aspect of the present invention relates to a method of detecting a cancer in a subject comprising detecting elevated p-STAT3 expression, as compared to normal controls, in PBMCs of said subject. The subject may be a human. The detecting may comprise FACS analysis. The cancer may be selected from the list consisting of melanoma, glioma (e.g., astrocytoma, glioblastoma multiforme), leukemia, squamous cell carcinoma, pancreatic cancer, bladder cancer, b-cell non-Hodgkins lymphoma, myeloma, chronic myelogenous leukemia, cervical cancer, breast cancer, and lung cancer.

A further aspect of the present invention relates to a method of monitoring the progression of a cancer in a subject comprising measuring p-STAT3 level in the blood of said subject at multiple time points, wherein an increase in p-STAT3 level over time indicates progression of said cancer. The subject may be a human. The detecting comprises FACS analysis. The multiple time points may be separated by at least one week. The frequency of said multiple time points may increase with time. The cancer may be selected from the list consisting of melanoma, glioma (e.g., astrocytoma, glioblastoma multiforme), leukemia, squamous cell carcinoma, pancreatic cancer, bladder cancer, B-cell non-Hodgkins lymphoma, myeloma, chronic myelogenous leukemia, cervical cancer, breast cancer, and lung cancer.

Yet another aspect of the present invention relates to a method of monitoring treatment of a cancer in a subject comprising measuring a p-STAT3 level in PBMCs of said subject at multiple time points, wherein a decrease in p-STAT3 level over time indicates treatment efficacy. The subject may be a human. The detecting may comprise FACS analysis. The multiple time points may be separated by at least one week. The frequency of said multiple time points may increase with time. The cancer may be selected from the list consisting of melanoma, glioma (e.g., astrocytoma, glioblastoma multiforme), leukemia, squamous cell carcinoma, pancreatic cancer, bladder cancer, B-cell non-Hodgkins lymphoma, myeloma, chronic myelogenous leukemia, cervical cancer, breast cancer, and lung cancer. The treatment may comprise administration of a chemotherapeutic, a radiotherapy, a gene therapy, a biological agent, or a surgery to a subject. The treatment may comprise administration of an immunotherapy or a p-STAT3 targeting agent, such as WP1066 or WP1220, to the subject.

In certain aspects, there is provided a method of monitoring the progression of a cancer in a subject comprising assessing p-STAT3 level in PBMCs of said subject at multiple time points, wherein an increase in p-STAT3 level over time indicates progression of the cancer.

In still yet another embodiment, there is provided a method of monitoring the treatment of a cancer in a subject comprising assessing a p-STAT3 level in PBMCs of said subject at multiple time points, wherein a decrease in p-STAT3 level over time indicates treatment efficacy.

The phrase “p-STAT3 targeting agent,” and used herein, refers to a compound which selectively inhibits the phosphorylation of STAT3 or the production of p-STAT3 in a cell. The cell is preferably a mammalian or human cell, such as a cancerous cell over-expressing p-STAT3. Certain p-STAT3 targeting agents, such as WP1066 and WP1220, are disclosed in U.S. application Ser. No. 11/010,834 and may be used with the present invention.

The use of the word “a” or “an” when used in conjunction with the term “comprising” in the claims and/or the specification may mean “one,” but it is also consistent with the meaning of “one or more,” “at least one,” and “one or more than one.”

It is contemplated that any embodiment discussed in this specification can be implemented with respect to any method or composition of the invention, and vice versa. Furthermore, compositions of the invention can be used to achieve methods of the invention.

Throughout this application, the term “about” is used to indicate that a value includes the inherent variation of error for the device, the method being employed to determine the value, or the variation that exists among the study subjects.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1: p-STAT3 expression in PBMCs from healthy donors and melanoma brain metastasis patients. PBMCs were isolated from blood samples obtained from healthy donors (n=14) and melanoma brain metastasis patients (n=10), fixed in paraformaldehyde, permeabilized, stained with mouse PE-labeled anti-human p-STAT3 (Y705) antibody, and analyzed by FACS. The percentage of p-STAT3-positive PBMCs differed significantly (p<0.05) between healthy donors and melanoma brain metastasis patients.

FIG. 2: Expression of p-STAT3 is enhanced in PBMCs from glioma patients. PBMCs were isolated from blood samples obtained from healthy donors (N=19) and glioma patients (N=45). The samples were intracellularly stained with antihuman p-STAT3 and analyzed by FACS. The percentage of p-STAT3-positive PBMCs differed significantly between healthy donors and glioma patients. Abbreviations used: Anaplastic astrocytoma, AA; Anaplastic oligodendroglioma, AO; Glioblastoma multiforme, GBM; Normal, healthy donor, HD; Recurrent, REC; No progression, NP.

### DESCRIPTION OF ILLUSTRATIVE EMBODIMENTS

The present invention provides in certain aspects methods for detecting the presence of or increased risk to a cancer in a subject, such as a human patient. It has been discovered by the inventor that p-STAT3 can be measured in the peripheral blood of a subject, and increases in p-STAT3 expression (e.g., in peripheral blood mononuclear cells) can indicate the presence of a cancer in a patient. In certain embodiments, peripheral blood mononuclear cells (PBMC) and PBMC subsets including, e.g., dendritic cells, T cells, NK cells, and macrophages may be purified and tested for p-STAT3 expression. Without wishing to be bound by any theory, it is anticipated that the p-STAT3 expression in mononuclear cells in a subject may result from exposure to a p-STAT3-expressing cancer in a subject; thus, in certain embodiments, the present invention may be particularly useful for detecting cancers which express increased levels of p-STAT3.

Determination of p-STAT3 levels in the peripheral blood of a subject may be used to diagnose a cancer, prognosticate a cancer, monitor the progression of a cancer, and/or monitor the treatment of a cancer. In certain embodiments and as shown in the below examples, the cancer may be a glioma (e.g., a glioblastoma multiform, an astrocytoma), a melanoma, or other STAT-3 expressing malignancy such as leukemia, lung cancer, squamous cell carcinoma, cervical cancer, or pancreatic cancer, etc.

Various techniques, including FACS and/or PCR, may be used to measure p-STAT3 expression in the peripheral blood of a subject. In certain embodiments, it has been surprisingly discovered by the inventor that p-STAT3 expression in peripheral blood may be more accurately detected and/or measured if the blood sample is analyzed within a period of about 24 hours after the blood sample is obtained.

The methods of the present invention may also be useful in evaluating the therapeutic potential of a candidate drug or compound which may affect a STAT3 pathway. For example, p-STAT3 inhibitors enhanced T cells' cytotoxic activity against melanoma through the inhibition of Tregs, and that this may contribute to the antitumor activity of these agents against melanoma brain metastases (Kong et al., 2008). Delineating the mechanism of activity of STAT3 inhibitors presents an important consideration for the development of immune therapeutics, e.g., to treat cancers which have metastasized to the CNS.

### I. PHOSPHORYLATION STATUS OF STAT3 CAN MODULATE CANCER PHENOTYPE AND DEVELOPMENT

p-STAT3 may interact with cancers in a variety of ways, including promoting p-STAT3-mediated immune suppression. Mechanisms of immune evasion mediated by p-STAT3 include down regulation of the functional activity of antigen-presenting cells such as dendritic cells, including decreased expression of MHC class I molecules (Kortylewski et al., 2005); inhibition of apoptotic signal receptors; down modulation of co-stimulation; production of immunosuppressive cytokines (Ahmad et al., 2004; Ross et al., 2007); inhibition of the release of anti-inflammatory cytokines such as IL-6 (a potent up regulator of STAT3 phosphorylation) (Heinrich et al., 2003; Kurdi and Booz, 2007); induction of TGF-β, and IL-10 (Darnell Jr., 2002; Yu et al., 2007); and an increase of Tregs, which possess immunosuppressive activity towards antigens from the self, infectious agents, and tumors (Chattopadhyay et al., 2005; Kortylewski et al., 2005; Sonabend et al., 2008). Tregs are abundantly present within melanoma metastasis to the CNS (Kong et al., 2008), and this likely contributes to the immunosuppression and tumor immune evasion that counteract immunological clearance of the tumor. Clarification of the mechanisms underlying p-STAT3-mediated immune suppression may assist in the development of adjuvant immunotherapies for metastatic melanoma and gliomas but is complicated by the fact that p-STAT3 interacts with the immune system in multiple ways.

It is anticipated that measurement of p-STAT3 expression in peripheral blood could be advantageously used to monitor subjects receiving a drug clinically, e.g., during a drug trial and/or during treatment of a cancer. For example, these tests could be utilized to monitor immune therapeutic clinical trials employing anti-p-STAT3 agents or p-STAT3 targeting agents as a surrogate market of reversal immune suppression and/or anti-tumor effects. p-STAT3 targeting, and/or testing for p-STAT3 levels in blood may be advantageously used in combination with other immunotherapies such as IFN-α, IL-2, granulocyte-macrophage colony-stimulating factor, monoclonal antibodies against tumor antigens, and anticancer vaccines (Heimberger et al., 2003; Rietschel and Chapman, 2006).

### II. P-STAT3 ELEVATIONS IN BLOOD SAMPLES MAY BE USED TO DETECT THE PRESENCE OF CANCERS

Elevations in p-STAT3 in peripheral blood of a subject can indicate the presence of or increased risk to a cancer in a human patient. In certain embodiments and as shown in the below examples, the cancer may be a melanoma, a brain metastasis, a glioma, or other malignancy. In other embodiments, the present invention may be used to detect the presence of or increased risk to a cancer that is characterized by expression of p-STAT3. For example, elevations in p-STAT3 in peripheral blood may be used to detect the presence of or increased risk to a leukemia, squamous cell carcinoma, pancreatic cancer, bladder cancer, essentially any type of glioma, B-cell non-Hodgkins lymphoma, myeloma, chronic myelogenous leukemia, cervical cancer, breast cancer, and/or lung cancer. In certain embodiments, the cancer expresses increased levels of p-STAT3. As shown in the below examples, healthy donors had 4.8±3.6% of PBMCs that expressed p-STAT3, while the mean proportion of PBMCs displaying p-STAT3 in patients with glioblastoma multiform (GBM) was 11.8±13.5% (P=0.03). Compared to healthy donors, patients with anaplastic astrocytoma (WHO grade III) and recurrent GBM (WHO grade IV) had statistically significantly higher levels of the percent of PBMCs displaying p-STAT3. Moreover, in patients with gliomas that were resected but that were without recurrence, p-STAT3 levels were within the healthy donor range. These findings support the idea that p-STAT3 levels may be elevated in PBMCs when a tumor is present but not when there is no radiographic evidence of a tumor. For example, one of the GBM patients whose MRI was questionable for tumor progression had radiation necrosis confirmed by biopsy; the mean percent of PBMCs displaying p-STAT3 in this patient was 0.1%, suggesting an absence of tumor. Thus, evaluation of p-STAT3 expression may be used to resolve the diagnostic dilemma of radiation necrosis versus tumor necrosis.

Elevated p-STAT3 may be measured in the peripheral blood of a subject via methods including fluorescence activated cell sorting (FACS) and/or real-time PCR. Preferably, a blood sample is obtained from a subject and analyzed for p-STAT3 levels within a time period of less than about 24 hours, more preferably within a time period of less than about 12 hours, more preferably within a time period of less than about 6 hours after obtaining the sample. In certain embodiments, the blood sample may be analyzed within two days or several hours (e.g., less than about 24, 23, 22, 21, 20, 19, 18, 17, 16, 15, 14, 13, 12, 11, 10, 9, 8, 7, 6, 5, 4, 3, 2, or 1 hour) or even within an hour (e.g., within about 30 to 60 minutes or less). It is generally anticipated by the inventor that reduced timeframes for measurement of p-STAT3 in PBMCs after obtaining a blood sample can favorably affect p-STAT3 detection and/or reduce variability in p-STAT3 expression. The inventor has surprisingly discovered that, in certain embodiments, p-STAT3 levels in blood may decrease after a period of about 24 hours or longer.

Increased risk or the presence of a cancer can be indicated by p-STAT expression in at least about 6, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, or 10 percent or more of peripheral blood mononuclear cells in a sample taken from a subject.

A. FACS Analysis of p-STAT3

In certain preferred embodiments, FACS analysis is used to measure p-STAT3 expression in blood mononuclear cells. In certain embodiments, the following protocol may be utilized for the detection of p-STAT-3 expression in the peripheral blood of a subject, such as a cancer patient.

First, peripheral blood lymphocytes (PBL) may be isolated from a blood sample taken from the subject. The blood sample may be layered over ficoll, centrifuged for about 20 min at about 1200 g, and the buffy coat may be isolated from the blood sample. The cells may then be washed with about 15 mL PBS for about 10 min at about 1700 rpm, then for about 5 min at about 1600 rpm and for about 5 min at about 1500 rpm. Then the blood sample may be fixed. The cells (e.g., 5×10⁶ cells) may be resuspended briefly in about 0.5 ml PBS. Para-formaldehyde prewarmed to about 37° C. may be added to a final concentration of 2% para-formaldehyde. The cells may be fixed for 10 minutes at 37° C., and then the sample tubes may be chilled on ice for about 1 minute. The sample may then be permeabilized. The para-formaldehyde may be removed prior to permeabilization, and cells may be pelleted by centrifugation (e.g., about 1500 rpm for about 5 min) and resuspended in 90% methanol. The sample may then be incubated for about 30 minutes on ice and the cells may be pelleted by centrifugation (e.g., 1500 rpm for 5 min). Then the cells in the sample may be stained. Cells may be transferred to a centrifuge plate (e.g., 10⁶ cells per well to a 96 wells V bottom plate). The samples may then be spun for about 5 min at about 1500 rpm and washed once with FACS buffer for about 5 min at about 1500 rpm. The cells may then be resuspended in about 45 μl FACS buffer/well and about 5 μl of Mouse PE labeled anti-Human pSTAT3 (Y705), BD Cat No. 612569) may be added. About 5 μl of PE Mouse IgG2a-κ Isotype Control (eBiosciences Cat No. 12-4729-71) may be added to matched wells and incubated for about 60 min at room temperature. About 200 μl FACS buffer/well may be added and the samples may be spun for about 5 min at about 1500 rpm (380 g). The supernatant may be removed, and cells may be resuspended in about 250 μl FACS buffer/well and transferred to FACS tubes for Flow Analysis. Flow analysis may be performed, e.g., using a FACSCalibur™ (Becton Dickson) according to the manufacturer's instructions.

It is anticipated that modifications to the above FACS protocol may be effectively used for detection of p-STAT3 in a blood sample. For example, other labels compatible with a blue argon laser (488 nm) FACS, including green (e.g., FITC, Alexa Fluor 488, GFP, CFSE, CFDA-SE, DyLight 488), orange (e.g., PI), red (e.g., PerCP, PE-Alexa Fluor 700, PE-Cy5 (TRI-COLOR), PE-Cy5.5), or infra-red (e.g., PE-Alexa Fluor 750, PE-Cy7) labels may be used. Blue argon laser FACS are typically less expensive to purchase and operate and widely used at many healthcare and research facilities; thus, blue argon laser FACS may be preferably used in certain embodiments of the present invention. Nonetheless, red diode laser FACS (635 nm) or violet laser FACS (405 nm) may be used to detect and/or measure p-STAT3 in peripheral blood. Red diode laser fluorescent labels which may be used include, e.g., APC, APC-Cy7, Alexa Fluor 700, Cy5, and Draq-5. Violet laser fluorescent labels which may be used include, e.g., Pacific Orange, Amine Aqua, Pacific Blue, DAPI, and Alexa Fluor 405.

In other embodiments, other methods of flow cytometry may be used to detect p-STAT3 in a blood sample. For example, magnetic activated cell sorting (MACS) may be used in certain embodiments to detect p-STAT3 in a blood sample. For example, various MACS products are commercially available, including MACS MicroBeads™ columns or AutoMACS™ (Miltenyi Biotec, CA, USA), which may be used according to the manufacturer's instructions. Other methods for flow cytometry can be found in U.S. Pat. Nos. 4,284,412; 4,989,977; 4,498,766; 5,478,722; 4,857,451; 4,774,189; 4,767,206; 4,714,682; 5,160,974; and 4,661,913.

B. Real Time PCR

In certain embodiments, real-time PCR (also called quantitative real time polymerase chain reaction or Q-PCR) may be used to secondarily detect p-STAT3. Real-time PCR can measure total STAT3 levels but not p-STAT3 because phosphorylation occurs at the protein levels as quantified by Western Blot, FACS or IHC staining However, real-time PCR can quantify STAT3 mRNA in PBMCs to infer p-STAT3 expression because the amount of p-STAT3 determined by IHC staining has been correlated with overall levels of STAT3 (Park et al., 2008). STAT3 primers which may be utilized in a real-time PCR assay include Forward primer: 5′-CAT GTG AGG AGC TGA GAA CGG-3′ (SEQ ID NO:1) Reverse primer: 5′-AGG CGC CTC AGT CGT ATC TTT-3′ (SEQ ID NO:2).

Real time PCR is based on the detection and measurement of amplified DNA after each amplification cycle. For example, fluorescent dyes that intercalate with double-stranded DNA, and modified DNA oligonucleotide probes that fluoresce when hybridized with a complementary DNA may be used to quantify DNA accumulation between amplification cycles. Reverse transcription polymerase chain reaction may be used with real time PCR to quantify mRNA encoding STAT3 in blood mononuclear cells. In this way, it may be possible to infer p-STAT3 expression.

PCR primers may be checked for hairpin structure and/or dimers using the Oligonucleotide Analyzer program (available at www.mature.com/oligonucleotide.html). Software programs (e.g., MELTCAL software) may be used to check the cross-hybridization among the sequences of primers used in an assay and calculate melting temperatures using a nearest neighbor model. Preferably, sequences selected will meet the general requirements of primer design for real-time quantitative PCR suggested by the RotoGene Real-Time PCR system manual provided by Corbett Research or in Inglis et al., 2004. Primer sequences may also be analyzed for specificity using a BLAST SEARCH FOR SHORT, NEARLY EXACT MATCHES program; preferably, the primers will produce essentially no or no cross-reactivity with other non-target sequences.

Methods for PCR/real-time PCR which may be used with the present invention include, U.S. Pat. No. 5,364,790, U.S. Pat. No. 5,475,610, U.S. Pat. No. 5,527,510, U.S. Pat. No. 5,681,741, U.S. Pat. No. 5,716,784, U.S. Pat. No. 6,346,384, U.S. Pat. No. 7,122,799, U.S. Pat. No. 5,853,990, U.S. Pat. No. 5,593,867, U.S. Pat. No. 5,547,861, Nolan et al. (2006; Sails (2009); Higuchi et al. (1992; Higuchi et al. (1993); Mackay (2007); Wawrik et al. (2002); Logan et al. (2009).

C. Preparing Antibodies

While, as mentioned herein, various p-STAT3 antibodies are commercially available, additional p-STAT3 antibodies may be generated and used to detect p-STAT3 levels in peripheral blood. Methods for the production of antibodies are well known in the art, as described in see, e.g., Harlow and Lane, 1988; U.S. Pat. No. 4,196,265. The methods for generating monoclonal antibodies (MAbs) generally begin along the same lines as those for preparing polyclonal antibodies. The first step for both these methods is immunization of an appropriate host. As is well known in the art, a given composition may vary in its immunogenicity. It is often necessary therefore to boost the host immune system, as may be achieved by coupling a peptide or polypeptide immunogen to a carrier. Exemplary and preferred carriers are keyhole limpet hemocyanin (KLH) and bovine serum albumin (BSA). Other albumins such as ovalbumin, mouse serum albumin or rabbit serum albumin can also be used as carriers. Means for conjugating a polypeptide to a carrier protein are well known in the art and include glutaraldehyde, m-maleimidobencoyl-N-hydroxysuccinimide ester, carbodiimyde and bis-biazotized benzidine.

As also is well known in the art, the immunogenicity of a particular immunogen composition can be enhanced by the use of non-specific stimulators of the immune response, known as adjuvants. Exemplary and preferred adjuvants include complete Freund's adjuvant (a non-specific stimulator of the immune response containing killed Mycobacterium tuberculosis), incomplete Freund's adjuvants and aluminum hydroxide adjuvant.

The amount of immunogen composition used in the production of polyclonal antibodies varies upon the nature of the immunogen as well as the animal used for immunization. A variety of routes can be used to administer the immunogen (subcutaneous, intramuscular, intradermal, intravenous and intraperitoneal). The production of polyclonal antibodies may be monitored by sampling blood of the immunized animal at various points following immunization.

A second, booster injection, also may be given. The process of boosting and titering is repeated until a suitable titer is achieved. When a desired level of immunogenicity is obtained, the immunized animal can be bled and the serum isolated and stored, and/or the animal can be used to generate MAbs.

Following immunization, somatic cells with the potential for producing antibodies, specifically B lymphocytes (B cells), are selected for use in the MAb generating protocol. These cells may be obtained from biopsied spleens or lymph nodes. Spleen cells and lymph node cells are preferred, the former because they are a rich source of antibody-producing cells that are in the dividing plasmablast stage. Often, a panel of animals will have been immunized and the spleen of animal with the highest antibody titer will be removed and the spleen lymphocytes obtained by homogenizing the spleen with a syringe. Typically, a spleen from an immunized mouse contains approximately 5×10⁷ to 2×10⁸ lymphocytes.

The antibody-producing B lymphocytes from the immunized animal are then fused with cells of an immortal myeloma cell, generally one of the same species as the animal that was immunized. Myeloma cell lines suited for use in hybridoma-producing fusion procedures preferably are non-antibody-producing, have high fusion efficiency, and enzyme deficiencies that render then incapable of growing in certain selective media which support the growth of only the desired fused cells (hybridomas).

Any one of a number of myeloma cells may be used, as are known to those of skill in the art (Goding, pp. 65-66, 1986; Campbell, pp. 75-83, 1984). For example, where the immunized animal is a mouse, one may use P3-X63/Ag8, X63-Ag8.653, NS1/1.Ag 4 1, Sp210-Ag14, FO, NSO/U, MPC-11, MPC11-X45-GTG 1.7 and S194/5XX0 Bul; for rats, one may use R210.RCY3, Y3-Ag 1.2.3, IR983F and 4B210; and U-266, GM1500-GRG2, LICR-LON-HMy2 and UC729-6 are all useful in connection with human cell fusions.

One preferred murine myeloma cell is the NS-1 myeloma cell line (also termed P3-NS-1-Ag4-1), which is readily available from the NIGMS Human Genetic Mutant Cell Repository by requesting cell line repository number GM3573. Another mouse myeloma cell line that may be used is the 8-azaguanine-resistant mouse murine myeloma SP2/0 non-producer cell line.

Methods for generating hybrids of antibody-producing spleen or lymph node cells and myeloma cells usually comprise mixing somatic cells with myeloma cells in a 2:1 proportion, though the proportion may vary from about 20:1 to about 1:1, respectively, in the presence of an agent or agents (chemical or electrical) that promote the fusion of cell membranes. Fusion methods using Sendai virus have been described by Kohler and Milstein (1975; 1976), and those using polyethylene glycol (PEG), such as 37% (v/v) PEG, by Gefter et al. (1977). The use of electrically induced fusion methods also is appropriate (Goding, pp. 71-74, 1986).

Fusion procedures usually produce viable hybrids at low frequencies, about 1×10⁻⁶ to 1×10⁻⁸. However, this does not pose a problem, as the viable, fused hybrids are differentiated from the parental, infused cells (particularly the infused myeloma cells that would normally continue to divide indefinitely) by culturing in a selective medium. The selective medium is generally one that contains an agent that blocks the de novo synthesis of nucleotides in the tissue culture media. Exemplary and preferred agents are aminopterin, methotrexate, and azaserine. Aminopterin and methotrexate block de novo synthesis of both purines and pyrimidines, whereas azaserine blocks only purine synthesis. Where aminopterin or methotrexate is used, the media is supplemented with hypoxanthine and thymidine as a source of nucleotides (HAT medium). Where azaserine is used, the media is supplemented with hypoxanthine.

The preferred selection medium is HAT. Only cells capable of operating nucleotide salvage pathways are able to survive in HAT medium. The myeloma cells are defective in key enzymes of the salvage pathway, e.g., hypoxanthine phosphoribosyl transferase (HPRT), and they cannot survive. The B cells can operate this pathway, but they have a limited life span in culture and generally die within about two weeks. Therefore, the only cells that can survive in the selective media are those hybrids formed from myeloma and B cells.

This culturing provides a population of hybridomas from which specific hybridomas are selected. Typically, selection of hybridomas is performed by culturing the cells by single-clone dilution in microtiter plates, followed by testing the individual clonal supernatants (after about two to three weeks) for the desired reactivity. The assay should be sensitive, simple and rapid, such as radioimmunoassays, enzyme immunoassays, cytotoxicity assays, plaque assays, dot immunobinding assays, and the like.

The selected hybridomas are then serially diluted and cloned into individual antibody-producing cell lines, which clones can then be propagated indefinitely to provide MAbs. The cell lines may be exploited for MAb production in two basic ways. A sample of the hybridoma can be injected (often into the peritoneal cavity) into a histocompatible animal of the type that was used to provide the somatic and myeloma cells for the original fusion (e.g., a syngeneic mouse). Optionally, the animals are primed with a hydrocarbon, especially oils such as pristane (tetramethylpentadecane) prior to injection. The injected animal develops tumors secreting the specific monoclonal antibody produced by the fused cell hybrid. The body fluids of the animal, such as serum or ascites fluid, can then be tapped to provide MAbs in high concentration. The individual cell lines could also be cultured in vitro, where the MAbs are naturally secreted into the culture medium from which they can be readily obtained in high concentrations.

MAbs produced by either means may be further purified, if desired, using filtration, centrifugation and various chromatographic methods such as HPLC or affinity chromatography. Fragments of the monoclonal antibodies of the invention can be obtained from the purified monoclonal antibodies by methods which include digestion with enzymes, such as pepsin or papain, and/or by cleavage of disulfide bonds by chemical reduction. Alternatively, monoclonal antibody fragments encompassed by the present invention can be synthesized using an automated peptide synthesizer.

It also is contemplated that a molecular cloning approach may be used to generate monoclonals. For this, combinatorial immunoglobulin phagemid libraries are prepared from RNA isolated from the spleen of the immunized animal, and phagemids expressing appropriate antibodies are selected by panning using cells expressing the antigen and control cells e.g., normal-versus-tumor cells. The advantages of this approach over conventional hybridoma techniques are that approximately 10⁴ times as many antibodies can be produced and screened in a single round, and that new specificities are generated by H and L chain combination which further increases the chance of finding appropriate antibodies.

Various methods may be employed for the cloning an expression of human light and heavy chain sequences. Wardemann et al. (2003) and Takekoshi et al. (2001), both of which disclose such techniques, are hereby incorporated by reference.

Other U.S. patents, each incorporated herein by reference, that teach the production of antibodies useful in the present invention include U.S. Pat. No. 5,565,332, which describes the production of chimeric antibodies using a combinatorial approach; U.S. Pat. No. 4,816,567 which describes recombinant immunoglobin preparations; and U.S. Pat. No. 4,867,973 which describes antibody-therapeutic agent conjugates.

D. Immunologic Assays

It is anticipated that techniques including RIAs, ELISAs and Western blotting may be used in various embodiments to measure the p-STAT3 content of blood. In certain embodiments, these approaches may be used for research purposes or in instances where multiple blood samples may be easily obtained. These methods may be used for early detection and/or monitoring of a cancer, possibly prior to tissue invasion and metastasis.

Immunoassays can be classified according to the assay type, assay method and endpoint labeling method. These three major criteria for classification that have the greatest influence on the performance of test are, i) the use of a limited (type II) or excessive reagent format (type I), ii) the use of a homogeneous and heterogeneous format, iii) the use of a label or unlabelled assay format and the choice of label. The present invention contemplates the use of all these kinds of immunoassays.

1. Type I Assay

In Type I assay format, where antigen binds to an excess of antibody, the most common method is sandwich assay. In this approach, the first antibody (capture Ab) in excess is coupled to a solid phase. The bound antigen is then detected with a second antibody (indicator Ab) labeled with various indicators such as enzymes, fluorophores, radioisotopes, particles, etc. In this assay, the amount of indicator antibody captured on the solid phase is directory proportional to the amount of antigen in the sample.

ELISA assays may also be used to detect p-STAT3 in blood, e.g., after the PBMC membrane is permeabilized and the p-STAT3 placed into solution. For example, antibodies to p-STAT3 may be immobilized onto a selected surface, for example, a surface such as a microtiter well, a membrane, a filter, a bead or a dipstick. After washing to remove incompletely adsorbed material, it is desirable to bind or coat the surface with a non-specific agent that is known to be antigenically neutral with regard to the test sample, e.g., bovine serum albumin (BSA), casein or solutions of powdered milk. This allows for blocking of non-specific adsorption sites on the immobilizing surface and thus reduces the background caused by non-specific binding of antibody to antigen on the surface.

After binding of antibody to the surface and coating, the surface is exposed to urine, prostate fluid or semen. Following formation of specific immunocomplexes between antigens and the antibody, and subsequent washing, the occurrence and even amount of immunocomplex formation may be determined by subjecting the same to a second antibody having specificity for the antigen. Appropriate conditions preferably include diluting the sample with diluents such as BSA, bovine gamma globulin (BGG) and phosphate buffered saline (PBS)/Tween®. These added agents also tend to assist in the reduction of non-specific background. The detecting antibody is then allowed to incubate for from about 2 to about 4 hr, at temperatures preferably on the order of about 25° C. to about 27° C. Following incubation, the surface is washed so as to remove non-immunocomplexed material. A preferred washing procedure includes washing with a solution such as PBS/Tween®, or borate buffer.

To provide a detecting means, the second antibody will preferably have an associated label, e.g., an enzyme that will generate a color development upon incubating with an appropriate chromogenic substrate. Thus, for example, one will desire to contact and incubate the second antibody for a period of time and under conditions which favor the development of immunocomplex formation (e.g., incubation for 2 hr at room temperature in a PBS-containing solution such as PBS/Tween®).

After incubation with the second antibody, and subsequent to washing to remove unbound material, the amount of label is quantified (e.g., by incubation with a chromogenic substrate such as urea and bromocresol purple or 2,2′-azino-di-(3-ethyl-benzthiazoline)-6-sulfonic acid (ABTS) and H₂O₂, in the case of peroxidase as the enzyme label). Quantitation is then achieved by measuring the label, e.g., degree of color generation, e.g., using a visible spectrum spectrophotometer. Other potential labels include radiolabels, fluorescent labels, dyes and chemilluminescent molecules (e.g., luciferase).

2. Type II Assay

In Type II assay formats, a limited amount of antibody is used (insufficient to bind the entire antigen) a prefixed amount of labeled antigen competes with the unlabeled antigen in test sample for a limited number of antibody binding sites. The concentration of unlabeled antigen in specimen can be determined from the portion of labeled antigen that is bound to the antibody. Since most analyte molecules are not enough large to provide two different epitopes in this method, the response will be inversely proportional to the concentration of antigen in the unknown.

3. Homogenous and Heterogenous Assay

The use off either competitive or immunometric assays requires differentition of bound from free label. This can be archived either by separating bound from free label using a means of removing antibody (heterogeneous) or modulation of signal of the label when antigen is bound to antibody compared to when it is free (homogeneous).

Most solid phase immunoassays belong to the Heterogeneous Assay category. There are many ways of separating bound from free label such as precipitation of antibody, chromatographic method, and solid phase coupling antibody. Homogeneous assays do not require any of separation step to distinguish antigen bound antibody from free antibody. It has an advantage in automation, and typically is faster, easier to perform, and more cost-effective, but its specificity and sensitivity are lower.

4. Immunochromatography

There are two different immunochromatography assays based on porous materials—nitrocellulose or nylon membrane. Depending on the liquid migration method, these are classified as lateral flow assay (LFA) or flow through assay (FTA). LFA methods which may be used are described, e.g., in U.S. Pat. No. 6,485,982.

E. Dipstick Technology

It is anticipated that a migration-type assay could be used in certain aspects of the present invention to detect p-STAT3 in peripheral blood, e.g., after the PBMC membrane is permeabilized. For example, U.S. Pat. No. 4,366,241, and Zuk, EP-A 0 143 574 describe migration type assays in which a membrane is impregnated with the reagents needed to perform the assay. An analyte detection zone is provided in which labeled analyte is bound and assay indicia is read.

U.S. Pat. No. 4,770,853, WO 88/08534, and EP-A 0 299 428 describe migration assay devices which incorporate within them reagents which have been attached to colored direct labels, thereby permitting visible detection of the assay results without addition of further substances.

U.S. Pat. No. 4,632,901, disclose a flow-through type immunoassay device comprising antibody (specific to a target antigen analyte) bound to a porous membrane or filter to which is added a liquid sample. As the liquid flows through the membrane, target analyte binds to the antibody. The addition of sample is followed by addition of labeled antibody. The visual detection of labeled antibody provides an indication of the presence of target antigen analyte in the sample.

EP-A 0 125 118, disclose a sandwich type dipstick immunoassay in which immunochemical components such as antibodies are bound to a solid phase. The assay device is “dipped” for incubation into a sample suspected of containing unknown antigen analyte. Enzyme-labeled antibody is then added, either simultaneously or after an incubation period. The device next is washed and then inserted into a second solution containing a substrate for the enzyme. The enzyme-label, if present, interacts with the substrate, causing the formation of colored products which either deposit as a precipitate onto the solid phase or produce a visible color change in the substrate solution.

EP-A 0 282 192, disclose a dipstick device for use in competition type assays.

U.S. Pat. No. 4,313,734 describes the use of gold sol particles as a direct label in a dipstick device.

U.S. Pat. No. 4,786,589 describes a dipstick immunoassay device in which the antibodies have been labeled with formazan.

U.S. Pat. No. 5,656,448 pertains to dipstick immunoassay devices comprising a base member and a single, combined sample contact zone and test zone, wherein the test zone incorporates the use of symbols to detect analytes in a sample of biological fluid. A first immunological component, an anti-immunoglobulin capable of binding to an enzyme-labeled antibody, is immobilized in a control indicator portion. A second immunological component, capable of specifically binding to a target analyte which is bound to the enzyme-labeled antibody to form a sandwich complex, is immobilized in a test indicia portion. The enzyme-labeled antibody produces a visual color differential between a control indicia portion and a non-indicia portion in the test zone upon contact with a substrate. The device additionally includes a first polyol and a color differential enhancing component selected from the group consisting of an inhibitor to the enzyme and a competitive secondary substrate for the enzyme distributed throughout the non-indicia portion of the test zone.

F. Kits

In still further embodiments, the present invention concerns immunodetection kits for use with the immunodetection methods described above. The kits will include antibodies to p-STAT3, and may contain other reagents as well. The immunodetection kits will thus comprise, in suitable container means, a first antibody that binds to p-STAT3, and optionally a second and distinct antibody to p-STAT3.

In certain embodiments, the antibody to p-STAT3 may be pre-bound to a solid support, such as a column matrix, a microtitre plate, a filter, a membrane, a bead or a dipstick. The immunodetection reagents of the kit may take any one of a variety of forms, including antibodies to p-STAT3 containing detectable labels. As noted above, a number of exemplary labels are known in the art and all such labels may be employed in connection with the present invention.

The kits may further comprise a suitably aliquoted composition of p-STAT3, whether labeled or unlabeled, as may be used to prepare a standard curve for a detection assay. The components of the kits may be packaged either in aqueous media or in lyophilized form.

The container means of the kits will generally include at least one vial, test tube, flask, bottle, syringe or other container means, into which the antibody may be placed, or preferably, suitably aliquoted. The kits of the present invention will also typically include a means for containing the antibody, antigen, and any other reagent containers in close confinement for commercial sale. Such containers may include injection or blow-molded plastic containers into which the desired vials are retained.

### III. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Materials and Methods

### Human Subjects

Patients with brain metastases or gliomas, who were to undergo surgical resection, were recruited for the study. Peripheral blood was drawn from the patients intraoperatively. Peripheral blood was also drawn from healthy volunteer donors. This study was approved by the institutional review board of The University of Texas M. D. Anderson Cancer Center, and written informed consent was obtained.

Isolation of Peripheral Blood Mononuclear Cells and Staining for p-STAT3 Expression

Blood samples were mixed with an equal volume of sterile phosphate-buffered saline (PBS) and subjected to density gradient centrifugation using Ficoll-Paque (Amersham Biosciences, Piscataway, N.J.). Peripheral blood mononuclear cells (PBMCs) were isolated and washed twice with PBS. For fixation, 5×10⁶ cells were resuspended in 0.5 ml of PBS, 37° C. pre-warmed paraformaldehyde was added to achieve a final concentration of 1% or 2%, and the solution was incubated for 10 min at 37° C. and then chilled on ice for 1 min. For permeabilization, the paraformaldehyde was removed by pelleting the cells at 1500 rpm for 5 min and resuspending them in 90% methanol, and then the cells were incubated for 30 min on ice and pelleted at 1500 rpm for 5 min. 1×10⁶ cells were seeded in duplicate into wells of 96 v-bottom well plates, centrifuged for 5 min at 1500 rpm, and washed once with fluorescence-activated cell sorter (FACS) buffer (PBS with 0.5% bovine serum albumin [BSA]) for 5 min at 1500 rpm. The cells were resuspended in 45 μl of FACS buffer/well and 5 μl of mouse phycoerythrin (PE)-labeled anti-human p-STAT3 (Y705) antibody (BD Biosciences, San Jose, Calif.). Matched control wells included 5 μl of PE-labeled IgG2a-κ isotype control (eBioscience, San Diego, Calif.). The cells were incubated for 60 min at room temperature, washed with 200 μl of FACS buffer/well, centrifuged for 5 min at 1500 rpm, resuspended in 250 μl of FACS buffer/well, and transferred to FACS tubes for flow analysis with FACSCalibur (BD Biosciences).

Determination of Tregs in Peripheral Blood of Patients with Gliomas

For subset analysis, after we became proficient at analyzing PBMC p-STAT-3, after the isolation of PBMCs as described above, additional aliquots of approximately 2.5×106 cells were plated into duplicate wells of 96-well V bottomed plates. The cells were then centrifuged at 1500 rpm for 2.5 min, after which they were washed twice with FACS buffer at 1500 rpm for 2.5 min. Surface staining was done using 5 μL of FITC-labeled antihuman CD4 (Pharmingen, San Diego, Calif.) in 45 μL of FACS buffer and 5 μL of APC-labeled antihuman CD25 (Pharmingen) for 15 min at 4° C. Cells were then washed with FACS buffer and permeabilized with 1:3 Cytofix/Cytoperm (eBioscience) for 2 h at 4° C. The cells were then centrifuged at 1500 rpm for 2.5 min and washed once with FACS buffer and 3 times with 1:3 PermWash (eBioscience). The cells were stained intracellularly with 5 μL PE-antihuman FoxP3 antibody (eBioscience) diluted in 45 μL PermWash for 30 min at 4° C. For an isotype control, 5 μL PE-antimouse IgG antibody (eBioscience) diluted in 45 μL PermWash was added to matched wells. Cells were washed with 200 μL PermWash (BD Biosciences) and then with 200 μL FACS buffer, and then were transferred into FACS tubes for flow cytometry analysis. The calculated Treg fraction was designated as the number of CD4+CD25+FoxP3+ cells divided by the total CD4+ population.

Immunohistochemical analysis of p-STAT3 in gliomas After formalin-fixed, paraffin-embedded sections of the gliomas were deparaffinized in xylene, they were rehydrated in ethanol. Endogenous peroxidase was blocked with 0.3% hydrogen peroxide/methanol for 10 min at room temperature before antigen retrieval was begun. Antigen retrieval for p-STAT-3 consisted of immersing the sections in a citrate-buffered solution (pH 6.0) and heating them in a microwave oven for 20 min. The sections were then cooled to room temperature for 40 min. After blocking with a protein-block serum-free solution (DAKO, Carpinteria, Calif.), anti-p-STAT-3 (tyrosine₇₀₅) antibody (1:50; Cell Signaling Technology, Danvers, Mass., that recognizes the same epitope as Y705) was added, and specimens were incubated overnight in a humidified box at 4° C. Slides were secondarily stained with biotin labeled secondary antibody (biotinylated link universal solution) (DAKO) for 60 min at room temperature. Finally, streptavidin-horseradish peroxidase (DAKO) was added, and slides were incubated for 30 min at room temperature. Diaminobenzidine (DAKO) was used as the chromogen, and color development was stopped by gently dipping slides into distilled water. The nuclei were then counterstained with hematoxylin. A glioma tissue microarray [3] served as a positive control for p-STAT-3 staining. The negative control was created by omitting the primary antibody from the immunohistochemical analysis and replacing it with the protein-block serum-free solution.

Three independent observers (WH, YW, GNF) quantitatively evaluated p-STAT-3 by analyzing the core of each specimen using high-power fields (maximum: ×40 objective and ×10 eyepiece, Axioskop 40, Carl Zeiss, Inc). Each observer recorded the absolute number of tumor cells staining positive for nuclear p-STAT-3 per×200 highpower field. The endothelial cells and infiltrating immune cells displaying p-STAT-3 were not included in this number. If there were discrepancies between observers' recorded numbers, the observers recounted the number of positively stained cells in each specimen; if they still disagreed, the neuropathologist (GNF) conducted the final arbitration.

### Statistical Analysis

For each specimen, we attempted to analyze duplicate samples to measure the percentage of PBMCs displaying p-STAT-3. The sample size is denoted as N and the number of measurements is represented as n. Mixed models were used to compare differences in the percent of PBMCs displaying p-STAT-3 between patients with glioma and healthy donors. In this way, the correlation between the two samples from each subject was taken into consideration. The Spearman correlation was used to analyze the association between the Treg fraction and the scatter plot with Loess smooth curves were presented to demonstrate the relationship. Comparison of Treg fraction difference between normal and tumor patients was conducted using Wilcoxon tests. All computations were carried out in SAS software (version 9.1; SAS Institute, Cary, N.C.) and SPLUS software (version 8.0; TIBCO, Palo Alto, Calif.). Data are presented as means±standard errors (SEs). Values at which differences were considered statistically significant were P<0.05.

### Example 2

### p-STAT3 Detection in Blood for the Identification of Melanoma Patients with CNS Metastasis

The activation of signal transducer and activator of transcription 3 (STAT3) has been identified as a key mediator that drives the fundamental components of melanoma malignancy, including immune suppression in melanoma patients. We found that the mean percentage of peripheral blood mononuclear cells expressing phosphorylated STAT3 (p-STAT3) was significantly elevated in samples from patients with melanoma brain metastases compared to healthy donors.

Expression of p-STAT3 is Enhanced in PBMCs from Melanoma Brain Metastasis Patients

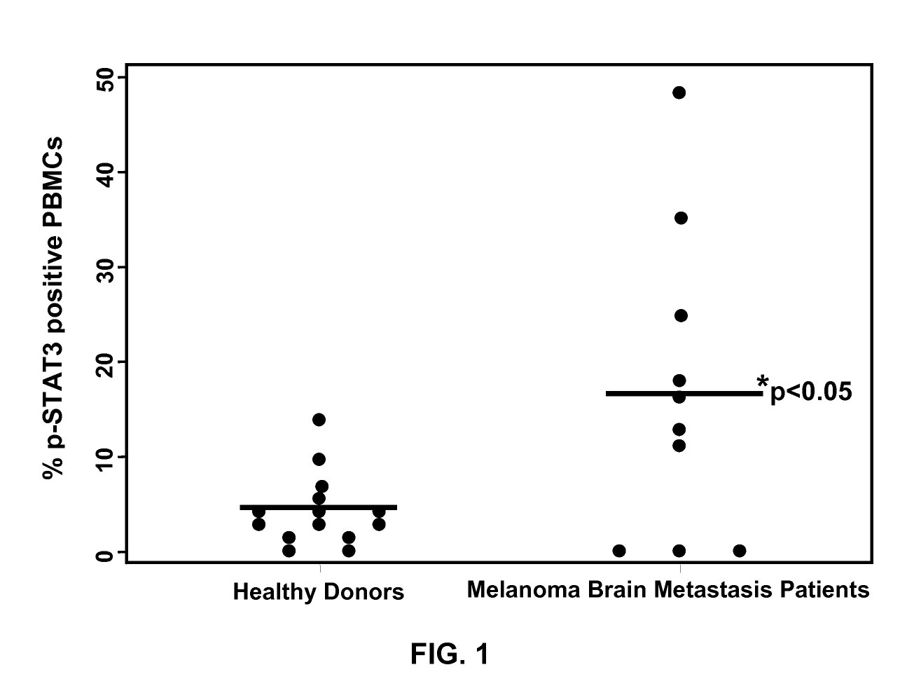

PBMCs were isolated from both healthy donors (n=14) and melanoma brain metastasis patients (n=10) and analyzed via FACS for p-STAT3 levels. The percentage of p-STAT3-expressing PBMCs from melanoma patients (16.13%±2.48%) was significantly elevated compared to the mean from healthy donors (4.17%±1.79%, p<0.05) (FIG. 1).

### Example 3

### p-STAT3 Detection in Blood for the Identification of Glioblastomas and Astrocytomas

### Study Population

This study included blood samples from 45 patients with gliomas who were treated at M. D. Anderson. Table 1 summarizes the overall composition of the study group and includes characteristics of the cohort, including age, gender, Karnofsky performance status score, and pathologic diagnosis. The glioblastoma multiforme (GBM) cases were further characterized according to whether the glioma was newly diagnosed, recurrent, or without tumor progression after undergoing surgical resection. The GBM patients without tumor progression on MRI consisted of two patients undergoing treatment with temozolomide and immunotherapy that were at least six months from their initial surgery and two patients undergoing surgical debridement for infection. One GBM patient undergoing stereotactic biopsy for determination of radiation necrosis was placed in the GBM without tumor progression group. The mean age for the healthy donors was 44±12.8 and 47% were male.

TABLE 1
Patient characteristics across different tumor types

| | | | | | Gender | | | |
|---|---|---|---|---|---|---|---|---|
| | | | Age | KPS | Female | | Male | |
| Pathology | WHO grade | Mean | Median (min, max) | Median (min, max) | N | % | N | % |
| Ganglioglioma | II | 34.7 ± 3.6 | 34.7 (32.1, 37.2) | 100 (100, 100) | 1 | 50.00 | 1 | 50.0 |
| AA/AO | III | 47.3 ± 8.6 | 49.4 (29.3, 56.8) | 90 (90, 100) | 3 | 30.00 | 7 | 70.0 |
| New GBM | IV | 57.2 ± 12.8 | 57.4 (26.4, 77.0) | 90 (60, 100) | 7 | 46.6 | 8 | 53.3 |
| Not Progressing GBM | IV | 54.2 ± 12.9 | 61.5 (39.3, 61.8) | 100 (90, 100) | 1 | 20.0 | 4 | 80.0 |
| Recurrent GBM | IV | 46.4 ± 19.4 | 47.1 (20.6, 68.9) | 80 (50, 100) | 4 | 30.8 | 9 | 62.2 |

WHO—World Health Organization; KPS—Karnofsky Performance Status

Determination of p-STAT-3 in PBMCs of Glioma Patients

Representative examples of PBMCs isolated from blood samples were obtained from healthy donors and patients with a variety of gliomas. The samples were fixed in paraformaldehyde, permeabilized, stained with mouse PE-labeled antihuman p-STAT3 (Y705) antibody, and analyzed by FACS. Sequential measurements of the same sample over time demonstrated a loss of p-STAT3 in fresh specimens after 24 h and in frozen specimens, indicating samples should be processed and analyzed as soon as possible after being collected from the patient. The MFI of p-STAT3 among samples was similar.

Higher Percentage of PBMCs Expresses p-STAT-3 in Glioma Patients than in Healthy Donors

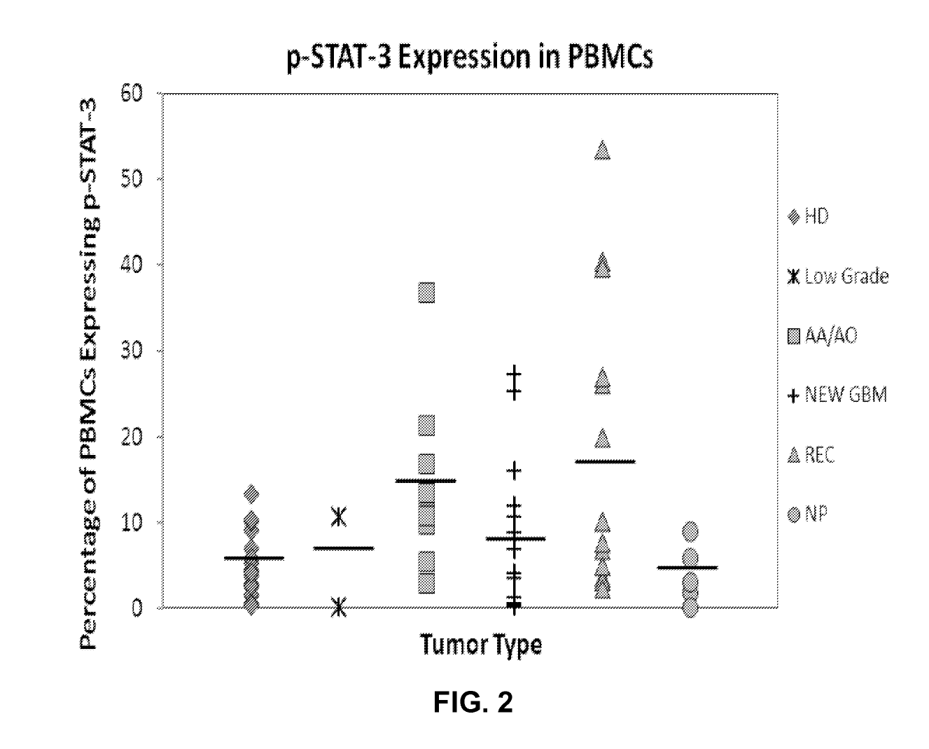

The mean percentage of PBMCs displaying p-STAT3 from all healthy donors (denoted by the diamonds) (N=19; n=38) was 4.8±3.6%. In all GBM patients (N=33; n=66), whether their disease was newly diagnosed (denoted by the cross symbol) or recurrent (denoted by the triangles), the mean number of PBMCs displaying p-STAT-3 was elevated to 11.8±13.5%, which was significantly higher than that in healthy donors (P=0.03) (FIG. 2). Among patients with recurrent GBM (denoted by the triangles) (N=13; n=24), the mean percentage of PBMCs displaying p-STAT3 was 18.8±17.1%, which was significantly higher than that in healthy donors (P=0.0002). However, in newly diagnosed GBM patients (N=15; n=30) the mean p-STAT3 level was 8.4±8.8%, which was not significantly different from that of healthy donors (P=0.3), although there was a trend toward increased levels in the GBM group.

Among grade III glioma patients (denoted by squares in FIG. 2) (N=10; n=20; six patients were progressive from grade II and two were recurrent), the mean percentage of PBMCs displaying p-STAT3 was 14.3±9.4%, an elevation that was also statistically significant (P=0.02) relative to healthy donor values. Because of insufficient patient numbers, no statistically meaningful conclusion can be drawn regarding differences in p-STAT3 levels between newly diagnosed and recurrent grade III gliomas. Because of the referral pattern of patients to M. D. Anderson, insufficient sample numbers were obtained from patients with low grade gliomas (denoted by stars in FIG. 2), precluding a sufficiently powered conclusion; however, the low-grade glioma samples that were analyzed and also drawn during general anesthesia did not express p-STAT3 levels above levels expressed in samples from healthy donors. Additionally, we did not detect elevations of the mean percentage of PBMC displaying p-STAT-3 (7.6+2.9%) in patients with a variety of metastasis to the CNS (n=6; including four lung carcinomas, one bladder and one parotid gland), indicating that general anesthesia is not a contributing factor in the percent of PBMCs displaying p-STAT-3.

Mean Percentage of PBMCs Displaying p-STAT3 in Patients Whose GBM is without Tumor Progression is within the Range of Healthy Donors

To determine if the mean percentage of PBMCs displaying p-STAT3 continued to be elevated in GBM patients who had undergone gross total resection and whose disease appeared not to be progressing clinically or on magnetic resonance imaging (MRI) (denoted by circles), we obtained peripheral blood from these patients. The mean percentage of p-STAT3 displaying PBMCs was 3.9±3.5%, which was within the range of healthy donors (FIG. 2).

Percentage of PBMCs Displaying p-STAT3 does not Correlate with the Percentage of p-STAT3 Positive Tumor Cells in the Glioma

To determine if the level of p-STAT3 positive cells in the glioma correlated to the mean percent of PBMCs displaying p-STAT3, we performed a subgroup analysis in which glioma specimens were stained with an antibody against p-STAT-3 and compared to the same patient's percentage of p-STAT3 positive PBMCs. In pair-wise scatter plots with Loess smooth curves showing the relationship between the mean percentage of PBMCs displaying p-STAT3 and the percentage of tumor cells displaying p-STAT3, the Spearman correlation was 0.46 and a nonlinear trend indicated that there was no correlation between tumor and PBMC p-STAT3 expression (P=0.15) (Table 2). When excluding the outlier (N=10), the Spearmen correlation is 0.51 (P=0.13).

TABLE 2
Correlation of the percentage of PBMCs displaying
p-STAT-3 compared to glioma expression

| | | % of glioma |
|---|---|---|
| | % of PBMCs | cells displaying |
| Pathology | displaying p-STAT-3 | nuclear p-STAT-3 |
| Ganglioglioma | 10.6 ± 0 | 87 |
| Ganglioglioma | 0.2 ± 0 | 33 |
| Recurrent AA | 12.8 ± 0.4 | 60 |
| Newly diagnosed GBM | 16.1 ± 0.4 | 83 |
| Newly diagnosed GBM | 0.1 ± 0 | 47 |
| Newly diagnosed GBM | 8.9 ± 0.4 | 43 |
| Recurrent GBM | 6.8 ± 0.4 | 68 |
| Recurrent GBM | 7.6 ± 0.2 | 70 |
| Recurrent GBM | 10.0 ± 0 | 43 |
| Recurrent GBM | 3.1 ± 0 | 47 |
| Recurrent GBM | 26.2 ± 23.7 | 53 |

Percentage of Tregs in the CD4+ Lymphocyte Population does not Correlate with Amount of p-STAT3 Expression

To determine if the percentage of PBMCs displaying p-STAT3 correlated with the degree of immune suppression as measured by the fraction of Tregs in the CD4+ compartment in glioma patients, we measured the percentage of FoxP3-positive Tregs in the CD4₊ lymphocyte population in a subset of GBM patients and compared the measurement to the same patient's percentage of p-STAT3 positive PBMCs. In pair-wise scatter plots with Loess smooth curves examining the relationship between the mean percent of PBMCs displaying p-STAT3 and the Treg fraction, the Spearman correlation was 0.03 and a nonlinear trend indicated that there was no correlation between the mean PBMC p-STAT3 expression and an enhanced Treg fraction (P=0.91). In healthy donors, the average fraction of FoxP3+ positive Tregs in the CD4+ population was 10±0.02% compared to 19±21.0% in the GBM patient population, indicating that the Treg fraction was elevated in GBM patients with p value of 0.86.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
U.S. application Ser. No. 11/010,834
U.S. Pat. No. 4,196,265
U.S. Pat. No. 4,284,412
U.S. Pat. No. 4,313,734
U.S. Pat. No. 4,366,241
U.S. Pat. No. 4,498,766
U.S. Pat. No. 4,632,901
U.S. Pat. No. 4,661,913
U.S. Pat. No. 4,714,682
U.S. Pat. No. 4,767,206
U.S. Pat. No. 4,770,853
U.S. Pat. No. 4,774,189
U.S. Pat. No. 4,786,589
U.S. Pat. No. 4,816,567
U.S. Pat. No. 4,857,451
U.S. Pat. No. 4,867,973
U.S. Pat. No. 4,989,977
U.S. Pat. No. 5,160,974
U.S. Pat. No. 5,364,790
U.S. Pat. No. 5,475,610
U.S. Pat. No. 5,478,722
U.S. Pat. No. 5,527,510
U.S. Pat. No. 5,547,861
U.S. Pat. No. 5,565,332
U.S. Pat. No. 5,593,867
U.S. Pat. No. 5,656,448
U.S. Pat. No. 5,681,741
U.S. Pat. No. 5,716,784
U.S. Pat. No. 5,853,990
U.S. Pat. No. 6,346,384
U.S. Pat. No. 6,485,982
U.S. Pat. No. 7,122,799
Abou-Ghazal M et al., Clin. Cancer Res., 14:8228-8235, 2008
Ahmad et al., Cancer Immunol. Immunother., 53:844-54, 2004.
Atkins et al., Cancer J. Sci. Am., 6(Suppl 1):S11-14, 2000.
Atkins et al., J. Clin. Oncol., 17:2105-2116, 1999.
Calzascia et al., Immunity, 22:175-84, 2005.
Campbell, In: Monoclonal Antibody Technology, Laboratory Techniques in Biochemistry and Molecular Biology, Burden and Von Knippenberg (Eds.), Elseview, Amsterdam, 13:71-74/75-83, 1984.
Chattopadhyay et al., Cancer Immunol. Immunother., 54:1153-61, 2005.
Cserr et al., Brain Pathol., 2:269-76, 1992.
Cserr et al., Immunol. Today, 13:507-12, 1992.
Darnell Jr., Nat. Reviews Cancer, 2:740-749, 2002.
EP-A 0 125 118
EP-A 0 143 574
EP-A 0 282 192
EP-A 0 299 428
Fecci et al., Cancer Res., 66:3294-3302, 2006.
Fecci et al., Clin. Cancer Res., 12:4294-305, 2006.
Fecci et al., Clin. Cancer Res., 13:2158-67, 2007.
Gefter et al., Somatic Cell Genet., 3:231-236, 1977.
Goding, In: Monoclonal Antibodies: Principles and Practice, 2d ed., Academic Press, Orlando, Fla., pp 60-61, 71-74, 1986.
Harlow and Lane, In: Antibodies: A Laboratory Manual, Cold Spring Harbor Laboratory, 1988.
Heimberger A B, Priebe W, Fokt I, Szymanski S, Hussain S F, Kong L-Y. Small molecule inhibitors for immune modulation. U.S. application Ser. No. 10/908,559, 2007.
Heimberger et al., Clin. Cancer Res., 9:4247-54, 2003.
Heinrich et al., Biochem. J., 374:1-20, 2003.
Hickey et al., J. Neurosci. Res., 28:254-60, 1991.
Hickey et al., GLIA, 36:118-24, 2001.
Higuchi et al., Biotechnology, 10:413-417, 1992.
Higuchi et al., Biotechnology, 11:1026-1030, 1993.
Hussain et al., Cancer Res., 67:9630-9636, 2007.
Inglis et al., Appl. Environ. Microbiol., 70(4):2296-2306, 2004.
Kinjyo et al., J. Exp. Med., 203:1021-31, 2006.
Kohler and Milstein, Eur. J. Immunol., 6:511-519, 1976.
Kohler and Milstein, Nature, 256:495-497, 1975.
Kong et al., Clin. Cancer Res., 14(18):5759-68, 2008.
Kong L-K et al., Cancer Immunol. Immunother., Epub ahead of print, 2008.
Kortylewski et al., Cancer Metastasis Rev., 24:315-27, 2005.
Kortylewski et al., Nat. Med., 11:1314-21, 2005.
Kurdi and Booz, J. Cardiovasc. Pharmacol., 50:126-41, 2007.
Lau et al., Neurotrauma, 18:351-359, 2001.
Li et al., Cancer Res., 63:7443-50, 2003.
Logan et al., In: Real-Time PCR: Current Technology and Applications, Caister Academic Press, ISBN 978-1-904455-39-4, 2009.
Mackay, In: Real-Time PCR in Microbiology, Caister Academic Press, ISBN 978-1-904455-18-9, 2007.
Madden et al., In: Proceedings 97th American Association for Cancer Research, Annual Meeting, Washington, D.C., 2006.
Nolan et al., Nat. Protoc., 1:1559-1582, 2006.
PCT Appln. WO 88/08534
PCT Appln. WO/104013214
Park et al., Oncol. Rep., 20(3): 597-604, 2008
Prendergast, Oncogene, 27:3889-900, 2008.
Priebe et al., Proceedings 97th American Association for Cancer Research, Annual Meeting, Washington, D.C., 2006.
Rietschel and Chapman, Hematol. Oncol. Clin. N. Am., 20:751-66, 2006.
Rosenberg et al., JAMA, 271:907-13, 1994.
Rosenberg et al., Nat. Med., 10:909-15, 2004.
Ross et al., Arch. Immunol. Ther. Exp. (Warsz), 55:231-45, 2007.
Sails, In: Real-Time PCR: Current Technology and Applications, Caister Academic Press, ISBN 978-1-904455-39-4, 2009.
Sonabend et al., Anticancer Res., 28:1143-50, 2008.
Sumimoto et al., J. Exp. Med., 203:1651-6, 2006.
Takekoshi et al., J. Biochem., 130:299-303, 2001.
Wang et al., Nat. Med., 10:48-54, 2004.
Wardemann et al. Science, 301(5638):1374-1377, 2003.
Wawrik et al., Appl. Environ. Microbiol., 68:3771-3779, 2002.
Williams et al., Curr. Top Microbiol. Immunol., 202:221-45, 1995.
Xie et al., Cancer Res., 66:3188-96, 2006.
Xie et al., Oncogene, 23:3550-60, 2004.
Yu et al., Nat. Rev. Immunol., 7:41-51, 2007.
Zorn et al., Blood, 108:1571-9, 2006.

1. A method for detecting, or determining an increased risk of developing, a cancer in a human subject comprising detecting expression of phosphorylated STAT3 (p-STAT3) in peripheral blood mononuclear cells (PBMCs) of such a subject, wherein detecting expression of p-STAT3 in greater than about 7% of such PBMCs indicates that the subject has or is at an increased risk of having the cancer.

2. The method of claim 1, wherein the method comprises contacting a sample comprising PBMCs with an antibody selective for p-STAT3; separating or quantifying cells based on binding to such an antibody; and determining the fraction of PBMCs that bind to the antibody.

3. The method of claim 2, wherein the method is carried out in a device adapted to separate or quantify cells on the basis of antibody binding, and further wherein said device is programmed to provide a report that identifies the fraction of PBMCs that bind to the antibody.

4. The method of claim 3, wherein said device is a fluorescence-activated cell sorting (FACS).

5. The method of claim 4, wherein said device is a blue argon laser FACS and the antibody is a Y705 antibody.

6. The method of claim 1, wherein said patient is suspected, or at risk, of having a cancer selected from the group consisting of melanoma, glioma, astrocytoma, glioblastoma multiforme, leukemia, squamous cell carcinoma, pancreatic cancer, bladder cancer, B-cell non-Hodgkins lymphoma, myeloma, chronic myelogenous leukemia, cervical cancer, breast cancer, and lung cancer.

7. The method of claim 6, wherein said cancer is a metastatic cancer.

8. The method of claim 7, wherein the metastatic cancer is present in the central nervous system of said subject.

9. The method of claim 1, wherein the expression of p-STAT3 in greater than about 7% of said peripheral blood mononuclear cells indicates that the subject has or is at an increased risk of having said cancer.

10. The method of claim 1, wherein p-STAT3 expression is observed in greater than about 7% of said peripheral blood mononuclear cells.

11. The method of claim 1, wherein p-STAT3 expression is observed in less than about 7% of said peripheral blood mononuclear cells.

12. A method of detecting a cancer in a subject comprising detecting elevated p-STAT3 expression, as compared to normal controls, in peripheral blood mononuclear cells (PBMCs) of said subject.

13. The method of claim 12, wherein said subject is a human.

14. The method of claim 12, wherein said detecting comprises FACS analysis.

15. The method of claim 12, wherein the cancer is selected from the list consisting of melanoma, glioma, astrocytoma, glioblastoma multiforme, leukemia, squamous cell carcinoma, pancreatic cancer, bladder cancer, B-cell non-Hodgkins lymphoma, myeloma, chronic myelogenous leukemia, cervical cancer, breast cancer, and lung cancer.

16. A method of monitoring the progression of a cancer in a subject comprising measuring p-STAT3 level in peripheral blood mononuclear cells (PBMCs) of said subject at multiple time points, wherein an increase in p-STAT3 level over time indicates progression of said cancer.

17. The method of claim 16, wherein said subject is a human.

18. The method of claim 16, wherein said detecting comprises FACS analysis.

19. The method of claim 16, wherein said multiple time points are separated by at least one week.

20. The method of claim 16, wherein frequency of said multiple time points increases with time.

21. The method of claim 16, wherein the cancer is selected from the list consisting of melanoma, glioma, astrocytoma, glioblastoma multiforme, leukemia, squamous cell carcinoma, pancreatic cancer, bladder cancer, B-cell non-Hodgkins lymphoma, myeloma, chronic myelogenous leukemia, cervical cancer, breast cancer, and lung cancer.

22. A method of monitoring treatment of a cancer in a subject comprising measuring a p-STAT3 level in peripheral blood mononuclear cells (PBMCs) of said subject at multiple time points, wherein a decrease in p-STAT3 level over time indicates treatment efficacy.

23. The method of claim 22, wherein said subject is a human.

24. The method of claim 22, wherein said detecting comprises FACS analysis.

25. The method of claim 22, wherein said multiple time points are separated by at least one week.

26. The method of claim 22, wherein frequency of said multiple time points increases with time.

27. The method of claim 22, wherein the cancer is selected from the list consisting of melanoma, glioma, astrocytoma, glioblastoma multiforme, leukemia, squamous cell carcinoma, pancreatic cancer, bladder cancer, B-cell non-Hodgkins lymphoma, myeloma, chronic myelogenous leukemia, cervical cancer, breast cancer, and lung cancer.

28. The method of claim 22, wherein said treatment comprises administration of a chemotherapeutic, a radiotherapy, a gene therapy, or a surgery to a subject.

29. The method of claim 22, wherein said treatment comprises administration of an immunotherapy or a p-STAT3 targeting agent to the subject.

30. The method of claim 29, wherein the p-STAT3 targeting agent is WP1066 or WP1220.
